(19) United States
(12) Patent Application Publication
(10) Pub. No.: US 2023/0405626 A1
(43) Pub. Date: Dec. 21, 2023

(54) HEIGHT-ADJUSTABLE SPRINKLER

(71) Applicant: Gyu Sik JO, Sejong (KR)

(72) Inventor: Gyu Sik JO, Sejong (KR)

(21) Appl. No.: 18/037,317

(22) PCT Filed: Nov. 10, 2021
(86) PCT No.: PCT/KR2021/016295

§ 371 Date: May 16, 2023

(30) Foreign Application Priority Data
Nov. 16, 2021 (KR) 10-2020-0152740

(51) Int. Cl. B05B 15/68; B05B 15/622

(52) U.S. Cl. CPC B05B 15/68; B05B 15/622; A01G 25/16

(57) ABSTRACT

A height-adjustable sprinkler and, more specifically, includes: a height-adjusting unit having a hollow upper socket, a hollow lower socket formed below the upper socket, and a hollow height-adjusting socket formed between the upper socket and the lower socket; and a sprinkler inserted into and accommodated in the height-adjusting unit, wherein the plurality of height-adjusting units are manufactured to have different heights, and the height-adjusting sockets are coupled between the upper socket and the lower socket according to the height at which the sprinkler is recessed from the ground, and thus the recessed height of the sprinkler is adjusted to be close to the ground.

### BACKGROUND

The present disclosure relates to a height-adjustable sprinkler and more specifically, relates to a height-adjustable sprinkler for easily controlling a height of the sprinkler through a height-adjusting unit.

In general cases, a sprinkler for laying (POP-UP type sprinkler) has been used for use such as water supply of a lawn or dust prevention of a playing field by installing in a playing field and a golf course to spray water. However, if the existing sprinkler is initially established, its height is fixed and thus, it is very difficult to control a head height of the sprinkler even though there is need to control the head height of the sprinkler.

Conventionally, it has been used in such a way that a saddle and the like are branched from one position of a water pipe and are connected to a connector, and then the sprinkler is connected to the end of the connector.

As a result of constructing in the above connection method, there have been various inconveniences such that there are phenomena that the head of the sprinkler is exposed over the ground due to loss of earth and sand by storm water and the like, and thus safety accidents of users may occur or a breakdown of the head of the sprinkler may result from movement of vehicles, and if there is a case that subsidence or fill-up of the construction ground is needed, a head part of the sprinkler is dented and deposits such as water and sand stagnate, and thus it causes defect occurrence. To solve these inconveniences, many studies have been done.

To solve the above, Korean registered utility model gazette No. 20-131661 (hereinafter, referred to as “related art”) describes a height-adjustable sprinkler which combines a height of a sprinkler by inserting or withdrawing a connector fixing the sprinkler into or from a water pipe and a fixing pipe in order to control a spraying height of water sprayed by the sprinkler. However, it is an actual state that problems appear such that the related art makes it possible to control a height but its operation method is inconvenient and if there is no close attention in control, a breakdown of a device may be followed.
Patent Document: Korean registered utility model gazette No. 20-131661.

### SUMMARY OF THE INVENTION

The present disclosure is conceived in consideration of the problems as the above, and an objective of the present disclosure is to provide a height-adjustable sprinkler for easily controlling a height of the sprinkler through a height-adjusting unit.

Another objective of the present disclosure is to provide a height-adjustable sprinkler for precisely controlling a dent height of the sprinkler in such a way that heights of a plurality of height-adjusting sockets are differently manufactured and an operation of combining a height-adjusting socket between an upper socket and a lower socket to match a height in which the sprinkler is dented from the ground is repeated.

Objectives of examples of the present disclosure are not limited to the noted objectives as the above and other objectives which are not noted may be clearly understood by a person with ordinary skill in the art to which the present disclosure pertain from the description below.

According to features to achieve objectives as the above, a height-adjustable sprinkler may be provided, wherein it includes a height-adjusting unit which has an upper socket formed with a hollow and a lower socket formed with a hollow below the upper socket, and has a height-adjusting socket formed with a hollow between the upper socket and the lower socket; and a sprinkler inserted and received into the height-adjusting unit, and wherein the height-adjusting socket is manufactured such that its height is different and it is plural, and the height-adjusting socket is combined between the upper socket and the lower socket according to a height in which the sprinkler is dented from the ground and a dent height of the sprinkler is controlled to be close to the ground.

Also, according to an example of the present disclosure, the height-adjustable sprinkler may be provided, wherein the height-adjusting socket includes an upper flange in which a screw thread is formed at an upper inner circumference; and a lower flange which is extended to the lower of the upper flange and in which a screw thread is formed at a lower outer circumference.

Also, according to an example of the present disclosure, the height-adjustable sprinkler may be provided, wherein the upper flange is mutually screwed to the screw thread formed at a lower outer circumference of the upper socket and the lower flange is mutually screwed to the screw thread formed at an upper inner circumference of the lower socket.

Also, according to an example of the present disclosure, the height-adjustable sprinkler may be provided, wherein the upper flange is mutually bolt-coupled to the upper socket and the lower flange is mutually bolt-coupled to the lower socket.

Also, according to an example of the present disclosure, the height-adjustable sprinkler may be provided, wherein a first step is formed at the upper of the upper flange and a second step is formed at the lower of the lower flange.

Also, according to an example of the present disclosure, the height-adjustable sprinkler may be provided, wherein the upper of the upper socket further includes a cover portion formed to be more protruded toward a horizontal circumference.

According to the height-adjustable sprinkler of the present disclosure, there is an effect of easily controlling a height of the sprinkler through the height-adjusting unit.

There is an effect of precisely controlling a dent height of the sprinkler in such a way that heights of a plurality of height-adjusting sockets are differently manufactured and an operation of combining the height-adjusting socket between the upper socket and the lower socket to match a height in which the sprinkler is dented from the ground is repeated.

### BRIEF DESCRIPTION OF THE DRAWINGS

FIG. 1 is a perspective view of a height-adjustable sprinkler according to an example of the present disclosure,

FIG. 2 is a cross sectional view of a height-adjusting unit according to an example of the present disclosure,

FIG. 3 is a cross sectional view of a height-adjusting unit according to another example of the present disclosure, and

FIG. 4 is a top plan view of a height-adjusting socket according to an example of the present disclosure.

### DESCRIPTION OF MAIN REFERENCE NUMERALS OF THE DRAWINGS

| | |
|---|---|
| 100: Height-adjusting unit | 110: Upper socket |
| 111: Cover portion | 120: Lower socket |
| 130: Height-adjusting socket | 131: Upper flange |
| 132: Lower flange | 133: First step |
| 134: Second step | 135: Protrusion |
| 200: Sprinkler | B: Bolt |
| N: Nut coupling hole | I: Bolt insertion hole |

### DETAILED DESCRIPTION OF THE INVENTION

The present disclosure is characterized such that it includes a height-adjusting unit which has an upper socket formed with a hollow and a lower socket formed with a hollow below the upper socket, and has a height-adjusting socket formed with a hollow between the upper socket and the lower socket; and a sprinkler inserted and received into the height-adjusting unit, wherein heights of the height-adjusting socket are differently and plurally manufactured and an inner diameter of the height-adjusting socket is identically manufactured, and the height-adjusting socket is combined between the upper socket and the lower socket according to a height in which the sprinkler is dented from the ground and a dent height of the sprinkler is controlled to be close to the ground.

The height-adjusting socket includes an upper flange in which a screw thread is formed at an upper inner circumference; and a lower flange which is extended to the lower of the upper flange and in which a screw thread is formed at a lower outer circumference. The upper flange is mutually screwed to a screw thread formed at a lower outer circumference of the upper socket and the lower flange is mutually screwed to a screw thread formed at an upper inner circumference of the lower socket. A first step is formed at the upper of the upper flange and a second step is formed at the lower of the lower flange. A plurality of unevennesses are formed on an inner circumference of the height-adjusting unit to improve a binding force with the sprinkler.

Hereinafter, objectives, other objectives, features, and advantages of the present disclosure may be easily understood via the following preferable examples related to the accompanying drawings. However, the present disclosure may be embodied in different forms, and should not be construed as being limited to the examples set forth here.

Rather, these examples are provided so that this disclosure will be through and complete and will fully convey the spirit of the disclosure to those skilled in the art.

Examples described and exemplified here also includes complementary examples.

In the specification, a singular form includes a plural form if there is no specific mention in phrases. ‘Comprise’ and/or ‘comprising’ used in the specification do not exclude presence or addition of one or more other components to the mentioned component.

Hereinafter, the present disclosure is specifically described by referring to the drawings. In describing specific examples below, various specific contents are described for more specifically explaining the present disclosure and assisting in understanding. However, a person having knowledge of this field to understand the present disclosure may recognize that it may be used without these various specific contents. It is priorly noted that in any case, parts which are commonly known and are not largely related to the present disclosure in describing the present disclosure are not described to prevent confusion from coming in describing the present disclosure.

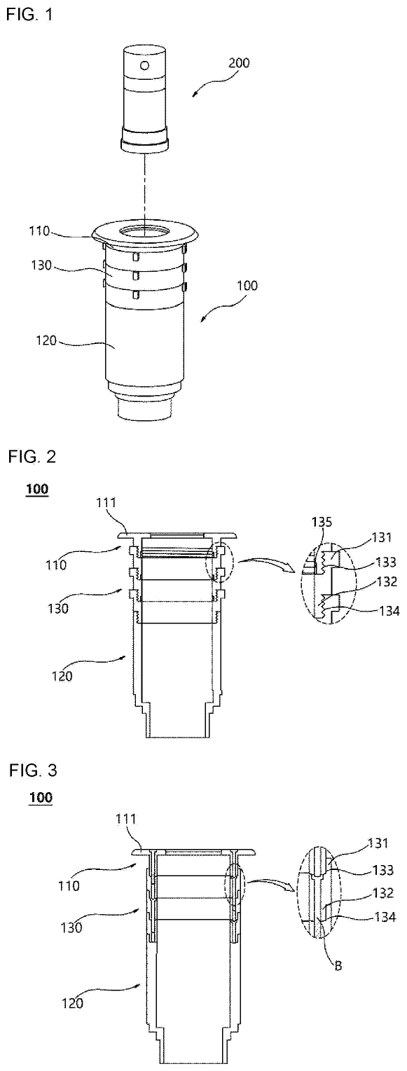

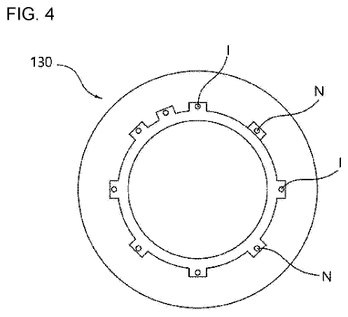

FIG. 1 is a perspective view of a height-adjustable sprinkler according to an example of the present disclosure, FIG. 2 is a cross sectional view of a height-adjusting unit according to an example of the present disclosure, FIG. 3 is a cross sectional view of a height-adjusting unit according to another example of the present disclosure, and FIG. 4 is a top plan view of a height-adjusting socket according to an example of the present disclosure.

As shown in FIGS. 1 to 4, a height-adjustable sprinkler of the present disclosure is configured to largely include a height-adjusting unit 100 and a sprinkler 200.

In advance, the height-adjusting unit 100 is configured to have an upper socket 110 formed with a hollow and a lower socket 120 formed with a hollow below the upper socket 110, and have a height-adjusting socket 130 formed with a hollow between the upper socket 110 and the lower socket 120.

Also, the sprinkler 200 is inserted and received into the height-adjusting unit 100.

That is, the height-adjusting unit 100 is formed with a hollow, so that the sprinkler 200 is inserted and received into the height-adjusting unit 100.

Also, a plurality of unevennesses are formed on an inner circumference of the height-adjusting unit 100, and thus a binding force with the sprinkler may be improved.

This sprinkler 200 is already known technologies as a sprinkling system which sprinkles water onto farmland, a lawn, or the like, and thus the description will be omitted hereinafter.

Meanwhile, the height-adjusting socket 130 is manufactured such that its height is different and it is plural, and a configuration is to combine the height-adjusting socket 130 between the upper socket 110 and the lower socket 120 according to a height in which the sprinkler 200 is dented from the ground and control a dent height of the sprinkler 200 to be close to the ground.

More specifically, the height-adjusting socket 130 may be manufactured such that its height is different and it is plural. For example, a height of the height-adjusting socket 130 may be manufactured and included as various heights such as 1 cm, 15 cm, 2 cm, 25 cm, and 3 cm.

Here, it is noted that a height of the height-adjusting socket 130 may be manufactured and included by those skilled in the art as various heights.

Hereinafter, a height dented from the ground to an end face of the upper of the sprinkler 200, that is, an end face of the upper of the upper socket 110 is measured, and if the measured dent height is 25 cm, the height-adjusting socket 130 having a height of 25 cm is prepared.

Through the above, the height-adjusting socket 130 having a height of 25 cm is combined between the upper socket 110 and the lower socket 120 and the dent height of the sprinkler 200 is controlled to be close to the ground.

As anther example, a height dented from the ground to an end face of the upper of the sprinkler 200, that is, an end face of the upper of the upper socket 110 is measured, and if the measured dent height is 15 cm, the height-adjusting socket 130 having a height of 15 cm is prepared.

Through the above, the height-adjusting socket 130 having a height of 15 cm is combined between the upper socket 110 and the lower socket 120 and the dent height of the sprinkler 200 is controlled to be close to the ground.

That is, the height-adjusting socket 130 is substituted and installed to match a dent height of the sprinkler 200, so that there are effects that there is no need to replace the whole height-adjusting unit 100 and through the above, it may be prevented that stocks of the height-adjusting unit 100 pile up and economic loss is caused to manufacturers.

Hereinafter, a first example of the height-adjusting socket 130 is explained.

As shown in FIG. 2, the height-adjusting socket 130 is configured to include an upper flange 131 in which a screw thread is formed at an upper inner circumference and a lower flange 132 which is extended to the lower of the upper flange 131 and in which a screw thread is formed at a lower outer circumference.

More specifically, the upper flange 131 is mutually screwed to a screw thread formed at a lower outer circumference of the upper socket 110 and the lower flange 132 is mutually screwed to a screw thread formed at an upper inner circumference of the lower socket 120.

As the above, the height-adjusting socket 130 may be coupled between the upper socket 110 and the lower socket 120 in a plurally-stacked structure through mutual screwing.

That is, the height-adjusting socket 130 may be coupled between the upper socket 110 and the lower socket 120 in a plurally-stacked structure through various examples.

Hereinafter, a second example of the height-adjusting socket 130 is explained.

As shown in FIG. 3, the upper flange 131 is mutually bolt-coupled to the upper socket 110 and the lower flange 132 is mutually bolt-coupled to the lower socket 120.

Meanwhile, a plurality of bolt insertion holes I for inserting a bolt B are formed to be spaced apart at certain intervals on an outer circumference of the upper socket 131. As shown in FIG. 4, the plurality of bolt insertion holes I and a plurality of nut coupling holes N for coupling with a bolt B are formed to be spaced apart at certain intervals and not to mutually cross on an outer circumference of the height-adjusting socket 130, and a plurality of nut coupling holes N for coupling with a bolt B are installed to be spaced apart at certain intervals on an outer circumference of the lower socket 120.

Through the above, a binding force among the upper socket 110, the lower socket 120, and the height-adjusting socket 130 may be improved, wherein the nut coupling holes N may be integrally installed on the outer circumference of the height-adjusting socket 130 and the outer circumference of the lower socket 120 or nut coupling holes N which are individually included may be coupled to improve a binding force with a bolt B.

Here, if the upper flange 131 is mutually bolt-coupled to the upper socket 110 and the lower flange 132 is mutually bolt-coupled to the lower socket 120, it is preferable that a bolt B coupled between the upper flange 131 and the upper socket 110 and a bolt B coupled between the lower flange 132 and the lower socket 120 should not be coupled collinearly in a height direction of the height-adjusting unit 100.

For example, if the bolt B coupled between the upper flange 131 and the upper socket 110 is installed at one side in the height direction of the height-adjusting unit 100, the bolt B coupled between the lower flange 132 and the lower socket 120 is installed at the other side in the height direction of the height-adjusting unit 100.

That is, they are installed in zigzags in the height direction of the height-adjusting unit 100, so that a binding force among the upper socket 110, the lower socket 120, and the height-adjusting socket 130 may be improved and an inconvenient problem that a bolt is come loose by vibration occurring upon a spraying operation of the sprinkler 200 and additional maintenance is needed may be prevented in advance.

As the above, the height-adjusting socket 130 may be coupled between the upper socket 110 and the lower socket 120 in a plurally-stacked structure through mutual bolt-coupling.

That is, the height-adjusting socket 130 may be coupled between the upper socket 110 and the lower socket 120 in a plurally-stacked structure through the aforementioned various examples.

Also, a first step 133 is formed at the upper of the upper flange 131 and a second step 134 is formed at the lower of the lower flange 132.

The first step 133 and the second step 134 as the above may be easily coupled from the upper in a lower direction when the upper socket 110, the lower socket 120, and the height-adjusting socket 130 are mutually coupled. Accordingly, a binding force among the upper socket 110, the lower socket 120, and the height-adjusting socket 130 may be improved.

Meanwhile, the first step 133 may be formed at the upper of the lower socket 120 and the second step 134 may be formed at the lower of the upper socket 110.

Through the above, the first step 133 formed at the upper of the upper flange 131 is mutually guided and coupled with the second step 134 formed at the lower of the upper socket 110, and the second step 134 formed at the lower of the lower flange 132 is mutually guided and coupled with the first step 133 formed at the upper of the lower socket 120.

Also, at least one or more protrusions 135 are installed at one side of the first step 133, wherein the protrusion 135 may improve a binding force in such a way that when the second step 134 is coupled with the first step 133, the first step 133 supports one side of the second step 134 and the protrusion 135 supports the other side of the second step 134.

Through the above, when the upper socket 110, the lower socket 120, and the height-adjusting socket 130 are mutually coupled, they are guided from the upper in a lower direction and may be easily coupled. Accordingly, a binding force among the upper socket 110, the lower socket 120, and the height-adjusting socket 130 may be improved.

In addition, an additional O-ring is installed around one side of the first step 133 and the second step 134, so that sealing among the upper socket 110, the lower socket 120, and the height-adjusting socket 130 may be maintained.

Meanwhile, the upper of the upper socket 110 may further include a cover portion 111 formed to be more protruded toward a horizontal circumference.

This cover portion 111 is installed to be parallel with the ground, wherein the cover portion 111 may support the ground in order that the height-adjusting unit 100 is not dented from the ground.

Here, the end of the cover portion 111 is formed to have curvature at a certain angle, wherein if a user supports the cover portion 111, there are effects that foreignness against the ground may be prevented and at the same time, an esthetic sense may be given.

Also, a reinforcement rib (not shown) is plurally installed at the lower of the cover portion 111, so that damage of the cover portion 111 due to an external force may be prevented.

Hereinafter, an operation method of the height-adjustable sprinkler according to the present disclosure is explained.

In advance, a height dented from the ground to an end face of the upper of the sprinkler 200, that is, an end face of the upper of the upper socket 110 is measured, and the height-adjusting socket 130 manufactured in the same height as the measured dent height is prepared.

Thereafter, the height-adjusting socket 130 manufactured in the same height as the measured dent height is combined between the upper socket 110 and the lower socket 120 and the dent height of the sprinkler 200 is controlled to be close to the ground.

Here, if the dent height of the sprinkler 200 is not close to the ground and there is a gap, a height dented from the ground to an end face of the upper of the sprinkler 200, that is, an end face of the upper of the upper socket 110 is remeasured, and the height-adjusting socket 130 manufactured in the same height as the measured dent height is prepared.

Thereafter, the height-adjusting socket 130 manufactured in the same height as the measured dent height is combined between the upper socket 110 and the lower socket 120 and the dent height of the sprinkler 200 is controlled to be close to the ground.

That is, the height-adjusting socket 130 is substituted and installed to match a dent height of the sprinkler 200, so that there is no need to replace the whole height-adjusting unit 100 and through the above, it may be prevented that stocks of the height-adjusting unit 100 pile up and economic loss is caused to manufacturers.

Therefore, according to the height-adjustable sprinkler of the present disclosure, there is an effect of easily controlling a height of the sprinkler through the height-adjusting unit.

There is an effect of precisely controlling a dent height of the sprinkler in such a way that heights of a plurality of height-adjusting sockets are differently manufactured and an operation of combining the height-adjusting socket between the upper socket and the lower socket to match a height in which the sprinkler is dented from the ground is repeated.

Examples described in the specification and configurations shown in the drawings are merely the most preferable example of the present disclosure and do not represent all the technical spirit of the present disclosure. Therefore, it should be understood that there may be various equivalents and variations which may substitute for these at a time point of filing the present application.

As the above, the height-adjustable sprinkler according to the present disclosure has an effect of easily controlling a height of the sprinkler through the height-adjusting unit, and there is an effect of precisely controlling a dent height of the sprinkler in such a way that heights of a plurality of height-adjusting sockets are differently manufactured and an operation of combining a height-adjusting socket between an upper socket and a lower socket to match a height in which the sprinkler is dented from the ground is repeated. Accordingly, its industrial applicability is very high.

1. A height-adjustable sprinkler, comprising: a height-adjusting unit which has an upper socket formed with a hollow and a lower socket formed with a hollow below the upper socket and has a height-adjusting socket formed with a hollow between the upper socket and the lower socket; and a sprinkler inserted and received into the height-adjusting unit, wherein heights of the height-adjusting socket are differently and plurally manufactured and an inner diameter of the height-adjusting socket is identically manufactured, and the height-adjusting socket is combined between the upper socket and the lower socket according to a height in which the sprinkler is dented from the ground and a dent height of the sprinkler is controlled to be close to the ground, wherein the height-adjusting socket includes an upper flange in which a screw thread is formed at an upper inner circumference; and a lower flange which is extended to the lower of the upper flange and in which a screw thread is formed at a lower outer circumference, wherein the upper flange is mutually screwed to a screw thread formed at a lower outer circumference of the upper socket and the lower flange is mutually screwed to a screw thread formed at an upper inner circumference of the lower socket, wherein a first step is formed at the upper of the upper flange and a second step is formed at the lower of the lower flange, and wherein a plurality of unevennesses are formed on an inner circumference of the height-adjusting unit to improve a binding force with the sprinkler.

2. The height-adjustable sprinkler of claim 1, wherein the upper flange is mutually bolt-coupled to the upper socket and the lower flange is mutually bolt-coupled to the lower socket.

3. The height-adjustable sprinkler of claim 1, wherein the upper of the upper socket further includes a cover portion formed to be more protruded toward a horizontal circumference.
